(19) United States
(12) Patent Application Publication
(10) Pub. No.: US 2021/0094300 A1
(43) Pub. Date: Apr. 1, 2021

(54) LIQUID EJECTING HEAD, LIQUID EJECTING APPARATUS, AND METHOD OF WIPING LIQUID EJECTING APPARATUS

(71) Applicant: SEIKO EPSON CORPORATION, Tokyo (JP)

(72) Inventor: Haruki KOBAYASHI, Matsumoto-shi (JP)

(21) Appl. No.: 16/890,184

(22) Filed: Jun. 2, 2020

(30) Foreign Application Priority Data
Sep. 30, 2019 (JP) 2019-178877
Sep. 30, 2019 (JP) 2019-178879
Mar. 31, 2020 (JP) 2020-062286

(51) Int. Cl. B41J 2/165; B41J 2/14

(52) U.S. Cl. CPC B41J 2/16544; B41J 2002/14491; B41J 2/1433

(57) ABSTRACT

A liquid ejecting head includes a nozzle plate including nozzle arrays having nozzles, a case head, a circuit board, a cover, and a first connector disposed on a supported surface of the circuit board. The nozzle arrays are arranged in a third direction perpendicular to a first direction. The case head includes a first side wall located at an end in the third direction thereof. The first connector is away in the third direction from the first side wall. The first connector includes first connection terminals arranged in a fifth direction perpendicular to the first direction and the third direction on the supported surface. The cover includes a first eaves portion protruding in the third direction with respect to the first side wall and extending in the fifth direction to overlap the first connection terminals.

The present application is based on, and claims priority from JP Application Serial Number 2019-178877, filed Sep. 30, 2019, JP application Serial Number 2019-178879, filed Sep. 30, 2019, and JP Application Serial Number 2020-062286, filed Mar. 31, 2020, the disclosures of which are hereby incorporated by reference herein in their entirety.

### BACKGROUND

### 1. Technical Field

The present disclosure relates to a liquid ejecting head, a liquid ejecting apparatus, and a method of wiping a liquid ejecting apparatus.

### 2. Related Art

As described in JP-A-2009-73082, a known liquid ejecting head includes a holder, a sheet, a drive circuit board, a resonator unit, a head case, a flow channel unit, and a head cover. The holder, the head case, and the head cover are fastened together by screws. The liquid ejecting head has a connector having a connection terminal on the lower surface of the drive circuit board.

### SUMMARY

However, in the above-described liquid ejecting head, the connection terminal of the connector is exposed to the outside, allowing liquid to readily adhere to the connection terminal.

A liquid ejecting head according to an aspect of the present disclosure includes a nozzle plate including nozzle arrays having nozzles through which a liquid is ejected in a first direction, a case head that is disposed adjacent to the nozzle plate in a second direction opposite the first direction and that has flow channels in communication with the nozzles, a circuit board that is disposed on a surface of the case head facing in the second direction and that has a supported surface supported by the case head, and a cover that has an opening in which the nozzles are exposed and that covers a portion of the nozzle plate. The nozzle arrays are arranged in a third direction perpendicular to the first direction. A first connector is disposed on the supported surface of the circuit board and is away in the third direction from a first side wall of the case head that is located at an end in the third direction. The first connector includes first connection terminals arranged in a fifth direction perpendicular to the first direction and the third direction on the supported surface. The cover includes a first eaves portion protruding in the third direction relative to the first side wall and extending in the fifth direction to overlap the first connection terminals.

A liquid ejecting apparatus according to an aspect of the present disclosure includes the above-described liquid ejecting head and a first signal cable inserted into the first connector.

A liquid ejecting apparatus according to an aspect of the present disclosure includes the above-described liquid ejecting head, a first signal cable inserted into the first connector, and a second signal cable inserted into the second connector.

A liquid ejecting apparatus according to an aspect of the present disclosure includes the above-described liquid ejecting head and a wiping member configured to wipe the nozzle plate. The wiping member is moved in the third direction or the fourth direction relative to the nozzle plate while in contact with the nozzle plate.

A liquid ejecting apparatus according to an aspect of the present disclosure includes the above-described liquid ejecting head and a wiping member configured to wipe the nozzle plate. The wiping member is moved in the third direction relative to the nozzle plate while in contact with the nozzle plate. The first eaves portion is longer in the third direction than the second eaves portion.

A liquid ejecting apparatus according to an aspect of the present disclosure includes the above-described liquid ejecting head and a wiping member configured to wipe the nozzle plate. The wiping member is moved in the third direction relative to the nozzle plate while in contact with the nozzle plate. The first eaves portion is longer in the fifth direction than the second eaves portion.

A method of wiping a liquid ejecting apparatus according to an aspect of the present disclosure includes moving a wiping member in contact with a nozzle plate in a third direction relative to the nozzle plate. The liquid ejecting apparatus includes a liquid ejecting head and the wiping member configured to wipe the nozzle plate. The liquid ejecting head includes a nozzle plate including nozzle arrays having nozzles through which a liquid is ejected in a first direction, a case head that is disposed adjacent to the nozzle plate in a second direction opposite the first direction and that has flow channels in communication with the nozzles, a circuit board that is disposed on a surface of the case head facing in the second direction and that has a supported surface supported by the case head, and a cover that has an opening in which the nozzles are exposed and that covers a portion of the nozzle plate. The nozzle arrays are arranged in a third direction perpendicular to the first direction. A first connector is disposed on the supported surface of the circuit board and is away in the third direction from a first side wall of the case head that is located at an end in the third direction. The first connector includes first connection terminals arranged in a fifth direction perpendicular to the first direction and the third direction on the supported surface. The cover includes a first eaves portion protruding in the third direction relative to the first side wall and extending in the fifth direction to overlap the first connection terminals. The nozzle arrays include ten nozzle arrays. A second connector is disposed on the supported surface of the circuit board and is away in a fourth direction opposite the third direction from a second side wall of the case head that is located at an end in the fourth direction. The second connector includes second connection terminals arranged in the fifth direction on the supported surface. The cover includes a second eaves portion protruding in the fourth direction relative to the second side wall and extending in the fifth direction to overlap the second connection terminals. The liquid ejecting head further includes a screw fastening the cover and the case head together. The first eaves portion is not in contact with the components of the liquid ejecting head other than the first eaves portion. The second eaves portion is not in contact with the components of the liquid ejecting head other than the second eaves portion. The first eaves portion is longer in the third direction than the second eaves portion.

A method of wiping a liquid ejecting apparatus according to an aspect of the present disclosure includes moving a wiping member in contact with a nozzle plate in a third direction relative to the nozzle plate. The liquid ejecting apparatus includes a liquid ejecting head and the wiping member configured to wipe the nozzle plate. The liquid ejecting head includes a nozzle plate including nozzle arrays having nozzles through which a liquid is ejected in a first direction, a case head that is disposed adjacent to the nozzle plate in a second direction opposite the first direction and that has flow channels in communication with the nozzles, a circuit board that is disposed on a surface of the case head facing in the second direction and that has a supported surface supported by the case head, and a cover that has an opening in which the nozzles are exposed and that covers a portion of the nozzle plate. The nozzle arrays are arranged in the third direction perpendicular to the first direction. A first connector is disposed on the supported surface of the circuit board and is away in the third direction from a first side wall of the case head that is located at an end in the third direction. The first connector includes first connection terminals arranged in a fifth direction perpendicular to the first direction and the third direction on the supported surface. The cover includes a first eaves portion protruding in the third direction relative to the first side wall and extending in the fifth direction to overlap the first connection terminals. The nozzle arrays include ten nozzle arrays. A second connector is disposed on the supported surface of the circuit board and is away in a fourth direction opposite the third direction from a second side wall of the case head that is located at an end in the fourth direction. The second connector includes second connection terminals arranged in the fifth direction on the supported surface. The cover includes a second eaves portion protruding in the fourth direction relative to the second side wall and extending in the fifth direction to overlap the second connection terminals. The liquid ejecting head further includes a screw fastening the cover and the case head together. The first eaves portion is not in contact with the components of the liquid ejecting head other than the first eaves portion. The second eaves portion is not in contact with the components of the liquid ejecting head other than the second eaves portion. The first eaves portion is longer in the fifth direction than the second eaves portion.

### BRIEF DESCRIPTION OF THE DRAWINGS

FIG. 1 is an explanatory view schematically illustrating a liquid ejecting apparatus.

FIG. 2 is an exploded perspective view schematically illustrating a liquid ejecting head.

FIG. 3 is an exploded perspective view schematically illustrating the liquid ejecting head.

FIG. 4 is an exploded perspective view schematically illustrating the liquid ejecting head.

FIG. 5 is a bottom view of a cover.

FIG. 6 is a bottom view of the liquid ejecting head.

FIG. 7 is a bottom view of the liquid ejecting head mounted on a carriage.

FIG. 8 is a cross-sectional view of the liquid ejecting head and the carriage taken along line VIII-VIII in FIG. 7.

FIG. 9 is a magnified view of an area indicated in FIG. 8.

FIG. 10 is a magnified view of the cover and the carriage in FIG. 9.

FIG. 11 is an explanatory view schematically illustrating a wiping process.

### DESCRIPTION OF EXEMPLARY EMBODIMENTS

### A1. Configuration of Liquid Ejecting Apparatus

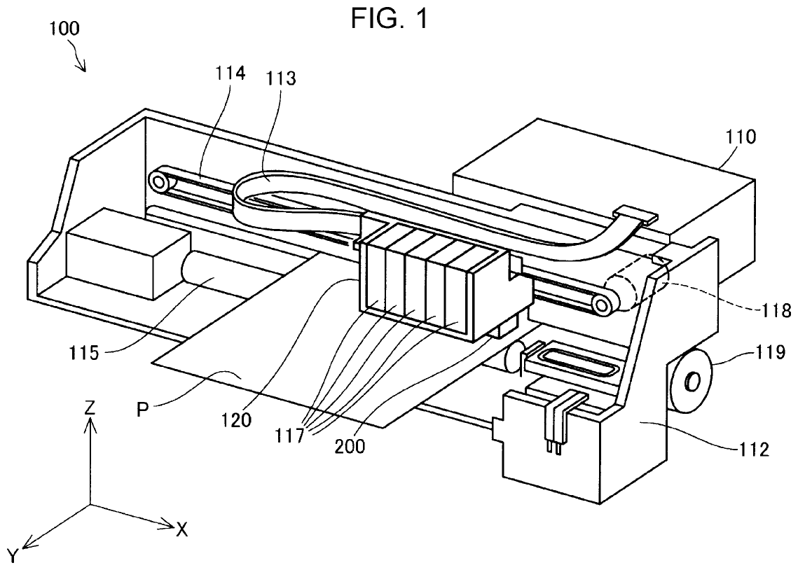

FIG. 1 is an explanatory view schematically illustrating a liquid ejecting apparatus 100 as an embodiment of the present disclosure. The liquid crystal ejecting apparatus 100 is an ink jet printer that ejects ink as a liquid. The liquid ejecting apparatus 100 converts image data sent from a liquid ejection controller (not illustrated) into dot on/off print data to be printed on a print medium P and ejects ink onto the print medium P in accordance with the print data. Thus, an image formed of dots is printed on the print medium P.

The liquid ejecting apparatus 100 includes a liquid ejecting head 200, a carriage 120, five ink cartridges 117, a carriage motor 118, a transportation motor 119, a drive belt 114, a flexible flat cable 113, a platen 115, a controller 110, and a housing 112.

The liquid ejecting head 200 is mounted on the carriage 120 and electrically coupled to the controller 110 through the flexible flat cable 113. The carriage 120, which is attached to a carriage guide (not illustrated), reciprocates in a main scanning direction X. The carriage 120 is coupled to the carriage motor 118 through the drive belt 114 and reciprocates in the main scanning direction X when the carriage motor 118 is driven. The housing 112 houses the liquid ejecting head 200, the carriage 120, the five ink cartridges 117, the carriage motor 118, the transportation motor 119, the drive belt 114, the flexible flat cable 113, and the platen 115. In FIG. 1, a portion of the housing 112 is not illustrated for ease of understanding of the inside of the housing 112. The housing 112 may house the controller 110.

The five ink cartridges 117 for five colors are mounted on the carriage 120. For example, cyan ink, magenta ink, yellow ink, matte black ink, and photo black ink are contained in the respective five ink cartridges 117. The liquid ejecting head 200 includes nozzle arrays 281, which have multiple nozzles 282 through which ink is ejected, on a surface facing the print medium P. The ink supplied from the ink cartridge 117 to the liquid ejecting head 200 is ejected in the form of liquid droplets through the nozzles 282 to the print medium P.

The transportation motor 119 is driven by control signals sent from the controller 110. The power of the transportation motor 119 is transmitted to the platen 115 to move the print medium P in a sub scanning direction Y.

The controller 110 includes at least one central processing unit (CPU), a processing circuit, such as a field programmable gate array (FPGA), and a memory circuit, such as a semiconductor memory, and collectively controls the transportation motor 119 and the carriage 120. Specifically described, upon completion of generation of print data, the controller 110 activates the transportation motor 119 to move the print medium P in the sub scanning direction Y to the print start position. The controller 110 activates the carriage motor 118 to move the carriage 120 in the main scanning direction X to the print start position. The controller 110 alternately performs an operation of moving the carriage 120 in the main scanning direction X while the liquid ejecting head 200 is ejecting ink onto the print medium P and an operation of driving the transportation motor 119 to move the print medium P in the sub scanning direction Y, which is a printing direction. Thus, an image is printed on the print medium P.

In FIG. 1, the carriage 120 reciprocates in the main scanning direction X, and the print medium P is transported from upstream to downstream in the sub scanning direction Y, which intersects the main scanning direction X. In this embodiment, the sub scanning direction Y is perpendicular to the main scanning direction X. The Z axis extends in the vertical direction. The X axis and the Y axis extend in the horizontal direction and are perpendicular to the Z axis. In these directions, directions pointed by arrows have a symbol “+” and directions opposite the directions pointed by the arrows have a symbol “−”. In the subsequent figures, the directions of the arrows correspond to those in FIG. 1. In the following description, the −Z direction, the +Z direction, the −X direction, the +X direction, the −Y direction, and the +Y direction may be, respectively, referred to as a first direction D1, a second direction D2, a third direction D3, a fourth direction D4, a fifth direction D5, and a sixth direction D6. The third direction D3 is perpendicular to the first direction D1. The fifth direction D5 is perpendicular to the third direction D3. The −Z direction corresponds to a vertically downward direction and the +Z direction corresponds to a vertically upward direction.

### A2. Configuration of Liquid Ejecting Head

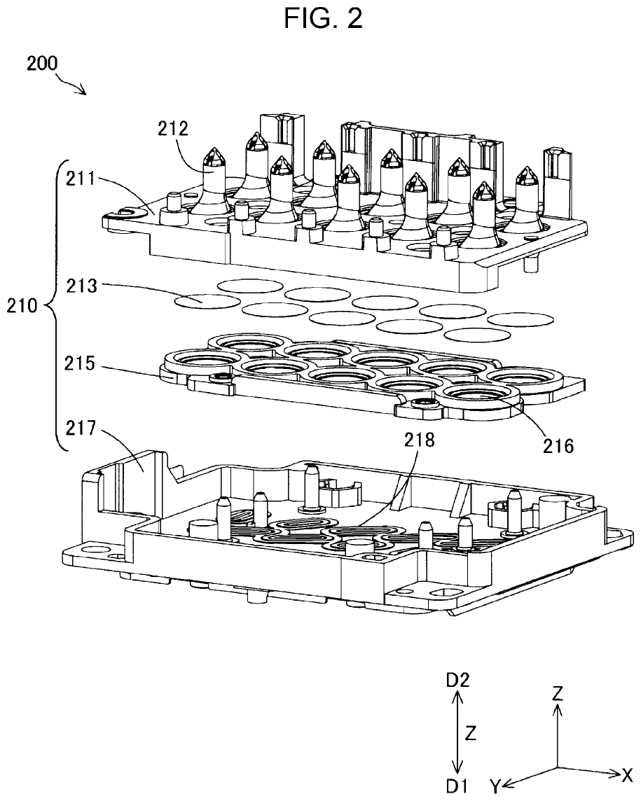

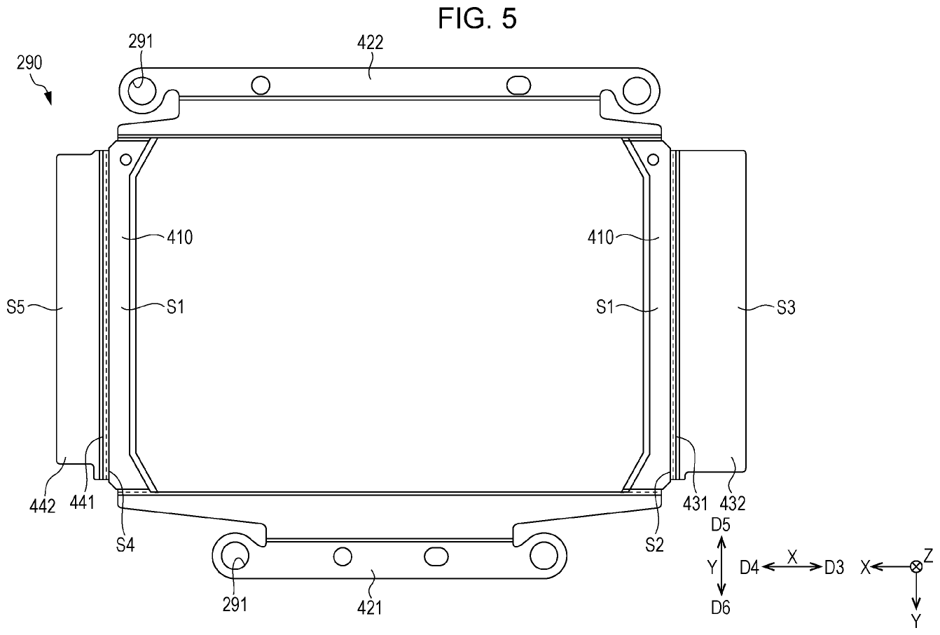

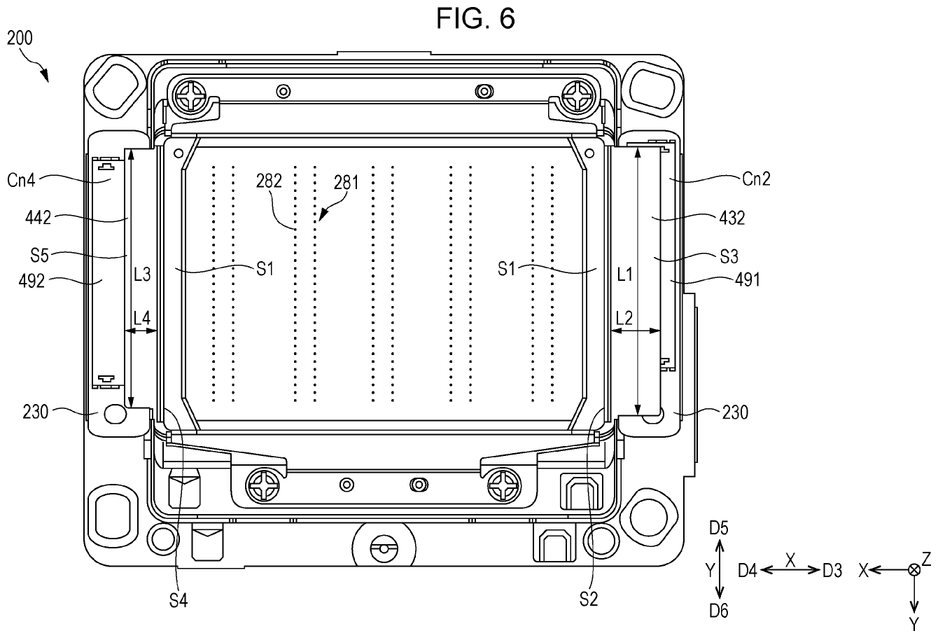

FIGS. 2, 3, and 4 are exploded perspective views schematically illustrating the liquid ejecting head 200. FIG. 5 is a bottom view of a cover 290. FIG. 6 is a bottom view of the liquid ejecting head 200. As illustrated in FIGS. 2, 3, and 4, the liquid ejecting head 200 includes, in this order from the second direction D2 to the first direction D1, a holder 210, a sealing member 220, a circuit board 230, an actuator unit 240, a case head 250, a vibration plate 260, a flow channel forming member 270, a nozzle plate 280, and the cover 290. The above-described components are stacked on top of another and fastened together by four screws 293, 294, 295, and 296 to form the liquid ejecting head 200.

As illustrated in FIG. 2, the holder 210 holds the ink cartridges 117 together with the carriage 120 and allows the ink from the ink cartridges 117 to flow to the case head 250 through flow channels in the holder 210. The holder 210 includes a first flow channel plate 211, filters 213, an attachment plate 215, and a second flow channel plate 217.

The first flow channel plate 211 includes ink supply needles 212. The ink from the ink cartridges 117 pass through the ink supply needles 212 to first flow channels 216 in the attachment plate 215, which are described later. The ink supply needle 212 includes a disc-like member and a needle protruding in the second direction D2. The ink supply needle 212 has a through hole extending in the Z direction. The through hole functions as an ink flow channel. Inserting a nail (not illustrated) of the ink cartridge 117 into the ink supply needle 212 fixes the ink cartridge 117 to the first follow channel plate 211.

The filters 213 remove air bubbles and foreign substances in the ink sent from the ink cartridges 117. The filter 213 has a disc-like shape and is fixed to the openings, which face in the second direction D2, of the first flow channels 216 in the attachment plate 215 by thermal adhesion or adhesion using an adhesive. For example, the filter 213 may be a sheet formed of metal woven fibers or resin woven fibers, which have multiple fine holes, or a metal plate or a resin plate, which has multiple fine through holes.

The attachment plate 215 is a long plate-like member having long sides extending in the X direction and has through holes constituting the first flow channels 216. The first flow channels 216 allows ink, from which foreign substances were removed by the filters 213, to flow to second flow channels 218 in the second flow channel plate 217.

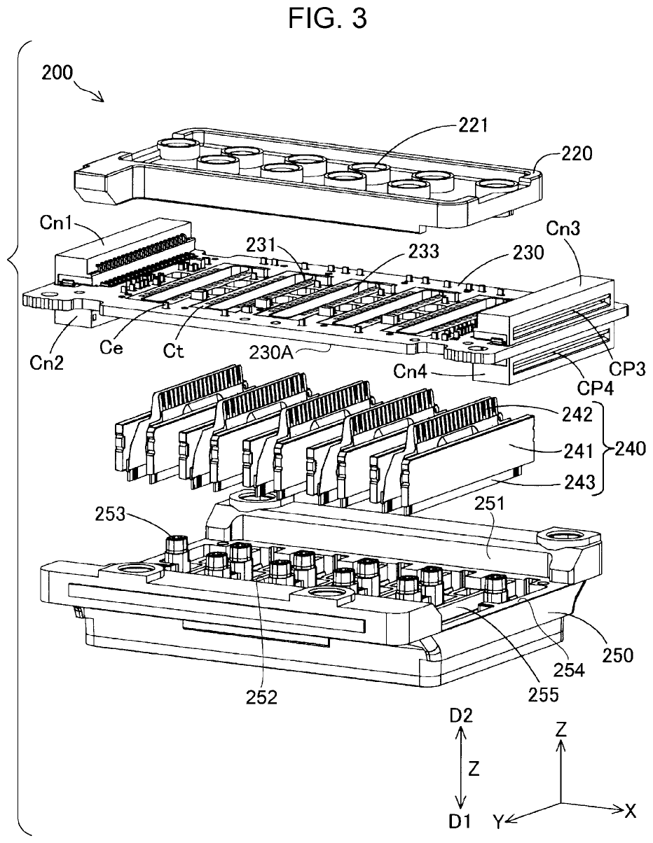

The second flow channel plate 217 is a long box-like member having long sides extending in the X direction and having an opening facing in the second direction D2. The second flow channel plate 217 has grooves constituting the second flow channels 218. The second flow channels 218 are grooves extending in the X direction in a surface of the second flow channel plate 217 facing in the second direction D2. The ink from the first flow channels 216 passes through the second flow channels 218 to ink inlets 221 in the sealing member 220 (FIG. 3), which are described later.

As described above, the first flow channels 216 allow the ink supplied from the ink cartridges 117 through the ink supply needles 212 to flow to the second flow channels 218, and the second flow channels 218 allow the ink sent from the first flow channels 216 to flow to the case head 250 through the ink inlets 221 in the sealing member 220.

As illustrated in FIG. 3, the sealing member 220 is a substantially rectangular plate-like member having long sides extending in the X direction. The sealing member 220 is formed of an elastic member, such as rubber and an elastomer. The sealing member 220 has the ink inlets 221.

The ink inlets 221 are through holes extending through the sealing member 220. The second flow channels 218 in the second flow channel plate 217 illustrated in FIG. 2 are in communication with third flow channels 253 in the case head 250 illustrated in FIG. 3 through the ink inlets 221. The ink supplied from the ink cartridges 117 flows into the case head 250 through the ink inlets 221. When the components of the liquid ejecting head 200 stacked on top of another are fastened together, the sealing member 220 is held tightly between the holder 210 (FIG. 2) and the case head 250 (FIG. 3) with a predetermined pressure. Thus, the sealing member 220 liquid-tightly seals between the second flow channels 218 of the holder 210 and the third flow channels 253 of the case head 250. Specifically described, the sealing member 220 allows the through holes constituting the second flow channels 218 in the surface of the second flow channel plate 217 facing in the first direction D1 to be in liquid-tight communication with the ink inlets 221. Furthermore, the sealing member 220 allows the ink inlets 221 to be in liquid-tight communication with the third flow channels 253.

The circuit board 230 is a substantially rectangular plate-like member having long sides extending in the X direction. As illustrated in FIGS. 2 and 3, the circuit board 230 is disposed between the holder 210 and the case head 250. As illustrated in FIG. 3, the circuit board 230 is adjacent to the sealing member 220 in the first direction D1. The circuit board 230 has a supported surface 230A supported by the case head 250 and is fixed to the case head 250 with an adhesive, for example, with the supported surface 230A being supported by a surface of the case head 250 facing in the second direction D2. The circuit board 230 is an electronic substrate integrally including wiring lines for driving piezoelectric elements 243 of an actuator unit 240, which is described later, and circuit elements Ce. The circuit board 230 includes the circuit elements Ce, the through holes 231, openings 233, connection terminals Ct, and connectors Cn1, Cn2, Cn3, and Cn4.

The circuit elements Ce are discrete components, such as a resistor, a capacitor, a transistor, and a coil. The circuit elements Ce are three-dimensionally disposed on a surface of the circuit board 230 facing in the second direction D2. In other words, the circuit elements Ce on the circuit board 230 slightly protrude in the second direction D2 from the surface of the circuit board 230 facing in the second direction D2.

The through holes 231 are through holes extending through the circuit board 230. When viewed in the first direction D1, the through holes 231 overlap the ink inlets 221 in the sealing member 220, and when viewed in the second direction D2, the through holes 231 overlap the third flow channels 253 in the case head 250, which are described later.

The openings 233 are through holes extending through the circuit board 230 and extending in the Y direction. The openings 233 are arranged in the X direction. The openings 233 receive COF substrates 242 of the actuator units 240. A portion of the COF substrate 242 protruding from the opening 233 in the second direction D2, which is located at the end in the second direction D2, is bent in the −X direction or the +X direction and coupled to the connection terminals Ct.

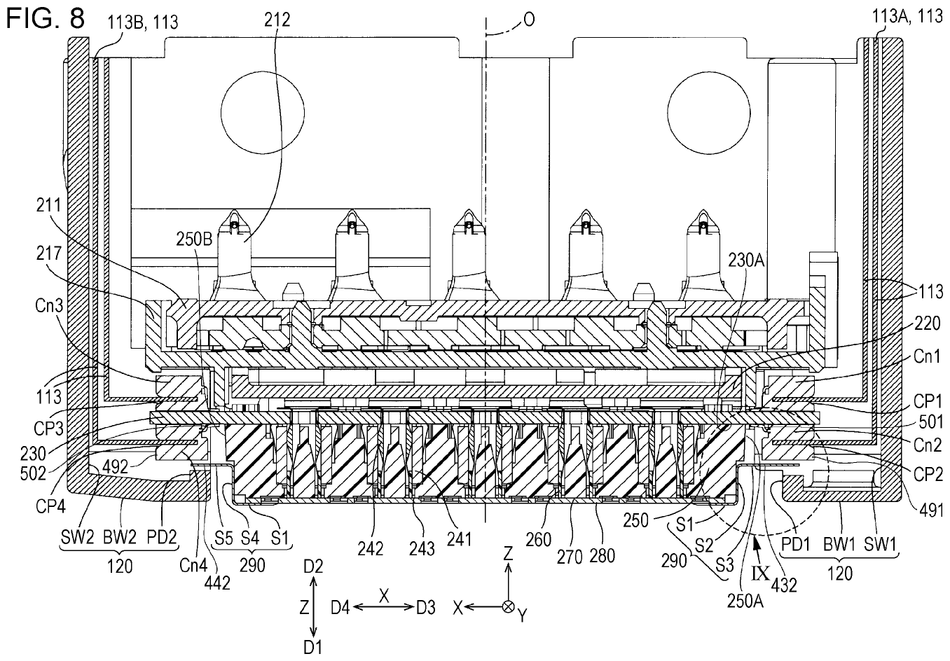

The connectors Cn1, Cn2, Cn3, and Cn4 are located at the ends in the X direction of the circuit board 230. Specifically described, the connector Cn1 is located at the end in the −X direction of the circuit board 230 and on the surface facing in the second direction D2. The connector Cn2 as a “first connector” is located at the end in the −X direction of the circuit board 230 and on the surface (the supported surface 230A) facing in the first direction D1. The connector Cn3 is located at the end in the +X direction of the circuit board 230 and on the surface facing in the second direction D2. The connector Cn4 as a “second connector” is located at the end in the +X direction of the circuit board 230 and on the surface (the supported surface 230A) facing in the first direction D1. The flexible flat cable 113, which is an example of a “signal cable”, is attached to the connectors Cn1, Cn2, Cn3, and Cn4. In this embodiment, a flexible flat cable 113A as a first signal cable is inserted into the connector Cn2, and a flexible flat cable 113B as a second signal cable is inserted into the connector Cn4 (FIG. 8). The connectors Cn1 and Cn2 have insertion slots CP1 and CP2 opening in the third direction D3, and the connectors Cn3 and Cn4 have insertion slots CP3 and CP4 opening in the fourth direction D4. The flexible flat cables 113 are inserted into the corresponding insertion holes CP1, CP2, CP3, and CP4, and thus the connectors Cn1, Cn2, Cn3, and Cn4 are electrically coupled to the flexible flat cables 113. Any type of signal cables may be attached to the connectors Cn1, Cn2, Cn3, and Cn4 instead of the flexible flat cable 113.

The actuator unit 240 includes the COF substrate 242, a fixing plate 241, and a piezoelectric element 243. The COF substrate 242 includes a drive circuit that drives the piezoelectric element 243. The COF substrate 242 is coupled to the piezoelectric element 243 at the end in the first direction D1. The COF substrate 242 is inserted in the opening 233 in the circuit board 230 and is coupled to the connection terminal Ct at the end in the second direction D2. The piezoelectric element 243 forms a piezoelectric element, which is a passive element using a piezoelectric effect, and drives upon receiving a drive signal from the controller 110. The fixing plate 241 is fixed to a wall defining a housing space 255 of the case head 250. The piezoelectric element 243 is fixed to the vibration plate 260 such that the end facing in the first direction D1 becomes a free end and is fixed to the end of the fixing plate 241 facing in the first direction D1 such that the end facing in the second direction D2 becomes a fixed end.

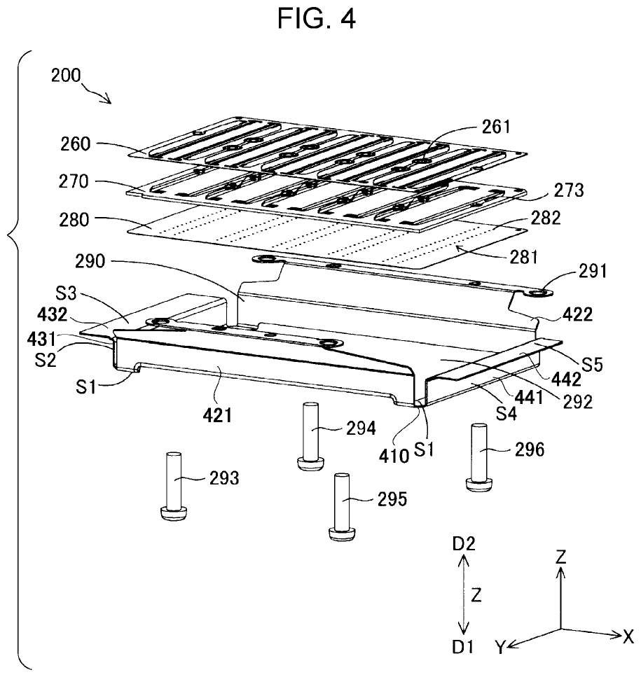

The case head 250 is disposed between the circuit board 230 and the vibration plate 260 (FIG. 4). For example, the case head 250 is formed of a synthetic resin, such as polypropylene. The case head 250 includes the housing spaces 255 and the third channels 253. The housing space 255 extends in the Y direction and is a recess opening in the second direction D2. The housing space 255 houses the COF substrate 242, the fixing plate 241, and the piezoelectric element 243. The third flow channels 253 are partly defined in cylindrical members protruding in the second direction D2. The third flow channels 253 are flow channels that allow the ink inlets 221 of the sealing member 220 to be in communication with ink inlets 261 of the vibration plate 260, which are described later, and are in communication with nozzles 282.

As illustrated in FIG. 4, the vibration plate 260 is a substantially rectangular plate-like member having long sides extending in the X direction. The vibration plate 260 is disposed between the case head 250 and the flow channel forming member 270. The vibration plate 260 functions a wall covering a surface of the flow channel forming member 270 facing in the second direction D2. The vibration plate 260 is elastically deformed by the piezoelectric elements 243. This allows the ink in a pressure chamber (not illustrated) to be ejected through the nozzle 282. The vibration plate 260 includes an elastic film formed of an elastic material, such as a resin film, and a supporting plate supporting the elastic film. The elastic film is attached to and supported by a surface of the supporting plate facing in the first direction D1.

The vibration plate 260 includes the ink inlets 261. The ink inlets 261 are through holes extending in the vibration plate 260. The ink inlets 261 are in communication with the third flow channels 253 and fourth flow channels 273 in the flow channel forming member 270, which are described later, and allow the ink supplied from the ink cartridges 117 to flow to the fourth flow channels 273.

The flow channel forming member 270 is a plate-like member having the same outer shape as the vibration plate 260. The flow channel forming member 270 is disposed between the case head 250 and the nozzle plate 280. The flow channel forming member 270 includes the fourth flow channels 273 and pressure chambers (not illustrated). The fourth flow channels 273 are in communication with the third flow channels 253 of the case head 250. The pressure chambers are recesses (not illustrated) in the flow channel forming member 270 that are covered by the vibration plate 260 from the second direction D2. In other words, the wall of the pressure chamber at the end in the second direction D2 is provided by the vibration plate 260, and the wall changes the capacity of the pressure chamber when deformed by deformation of the piezoelectric element 243.

Although not illustrated, the pressure chambers are arranged in the Y axis direction along the nozzle arrays 281. The pressure chambers are in communication with the fourth flow channels 273 and the nozzles 282. The ink arrived at the pressure chamber through the fourth flow channel 273 is ejected through the nozzle 282 when the capacity of the pressure chamber is changed. In this configuration, the first flow channel 216, the second flow channel 218, the third flow channel 253, and the fourth flow channel 273 are in communication with the same nozzle 282 through the pressure chamber. In this embodiment, the flow channel forming member 270 is formed of silicon (Si), for example. The flow channel forming member 270 may include laminated multiple plates.

The nozzle plate 280 is a thin plate-like member and has the same outer shape as the vibration plate 260 and the flow channel forming member 270. The nozzle plate 280 is adjacent to the flow channel forming member 270 in the first direction D1. The nozzle plate 280 includes nozzle arrays 281 having the nozzles 282 arranged in the Y direction. In this embodiment, the nozzle plate 280 includes ten nozzle arrays 281. The nozzle 282 is a through hole extending through the nozzle plate 280 and through which ink is ejected to the print medium P. The nozzle arrays 281 are arranged in the X direction. The nozzle arrays 281 are located at positions corresponding to the positions of the pressure chambers of the flow channel forming member 270. Portions of the nozzle plate 280 not having the nozzles 282 function as a wall covering a surface of the flow channel forming member 270 facing in the first direction D1. For example, the nozzle plate 280 is formed of stainless steel (SUS) or silicon (Si). The number of nozzle arrays 281 is not limited to ten and may be any number.

The case head 250, the vibration plate 260, the flow channel forming member 270, and the nozzle plate 280 are fixed to each other with an adhesive. Specifically described, the surface of the nozzle plate 280 facing in the second direction D2 and the surface of the flow channel forming member 270 facing in the first direction D1 are bonded together with an adhesive. The surface of the flow channel forming member 270 facing in the second direction D2 and the surface of the vibration plate 260 facing in the first direction D1 are bonded together with an adhesive. The surface of the vibration plate 260 facing in the second direction D2 and the surface of the case head 250 facing in the first direction D1 are bonded together with an adhesive. The adhesive may be applied to all the components 250, 260, 270, and 280.

The cover 290 is a frame body housing the vibration plate 260, the flow channel forming member 270, the nozzle plate 280, and a portion of the case head 250. The cover 290 is a box-like member having an opening 292 in which the nozzles 282 are exposed in the first direction D1 and covers a portion of the nozzle plate 280. The cover 290 is formed of a metal material, such as stainless steel (SUS). The cover 290 has a planar portion 410 having first surfaces S1 forming a bottom surface, a first side plate 431 having a second surface S2 forming a side surface, a second side plate 441 having a fourth surface S4 forming a side surface, a first eaves portion 432 having a flange-like third surface S3 extending outwardly from the second surface S2 at right angle, and a second eaves portion 442 having a flange-like fifth surface S5 extending outwardly from the fourth surface S4 at right angle. The cover 290 further includes fixing plates 421 and 422 having fixing portions 291. The second surface S2 and the fourth surface S4 have substantially the same configuration. The third surface S3 and the fifth surface S5 have substantially the same configuration. The cover 290 is formed of a single member and the surfaces of the cover 290 are continuous. Specifically described, the first surface S1, the second surface S2, and the third surface S3 are continuous. The first surface S1, the fourth surface S4, and the fifth surface S5 are continuous. The opening 292 defined by the first surface S1 allows the surface of the nozzle plate 280 facing in the first direction D1 to be exposed when the vibration plate 260, the flow channel forming member 270, the nozzle plate 280, and the case head 250 are housed in the cover 290. The cover 290 is described in detail later.

The cover 290 has four fixing portions 291 that receive screws 293, 294, 295, and 296. The cover 290 is fixed by the screws 293, 294, 295, and 296 to the holder 210 with the case head 250 and the circuit board 230 therebetween.

The components of the liquid ejecting head 200 are stacked and fastened together by the four screws 293, 294, 295, and 296. For example, the four screws 293, 294, 295, and 296 are full threaded bolts. The screws 293, 294, 295, and 296 are inserted into preformed screw holes (not illustrated) in the case head 250 and are fastened to fasten the holder 210, the case head 250, and the cover 290 together.

### A3. Arrangement of Cover and Carriage

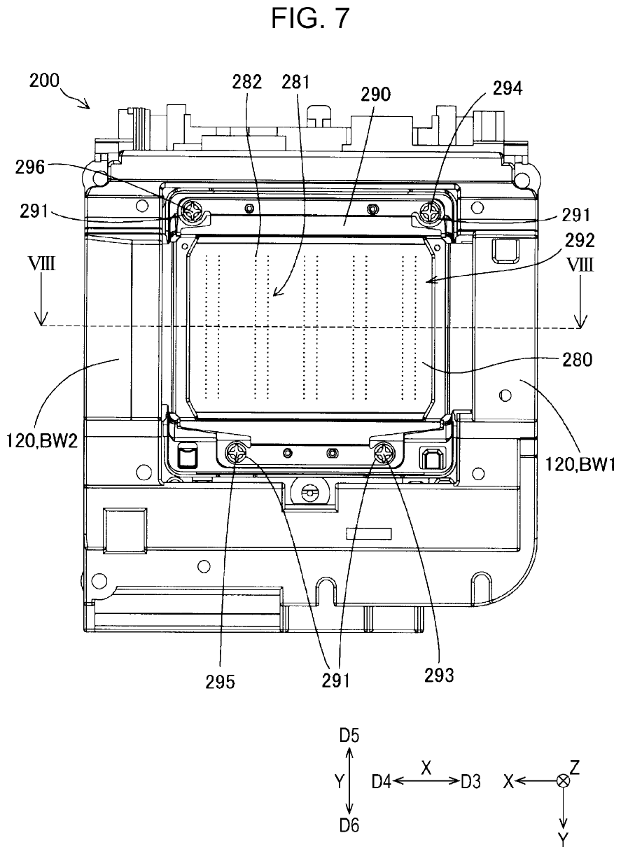

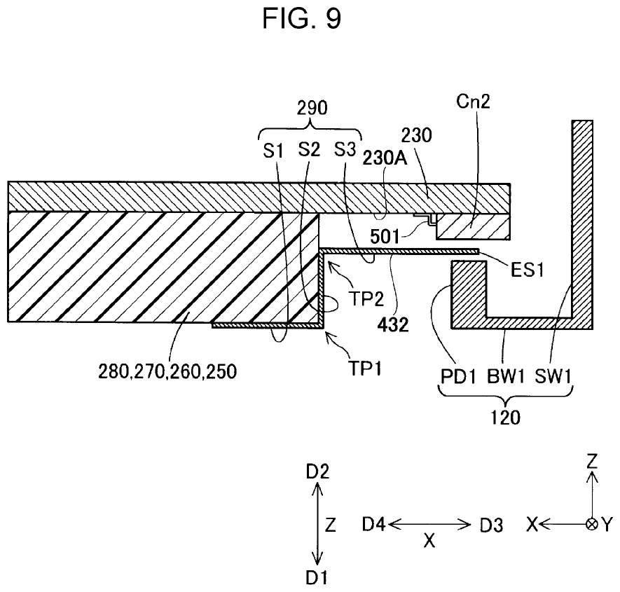

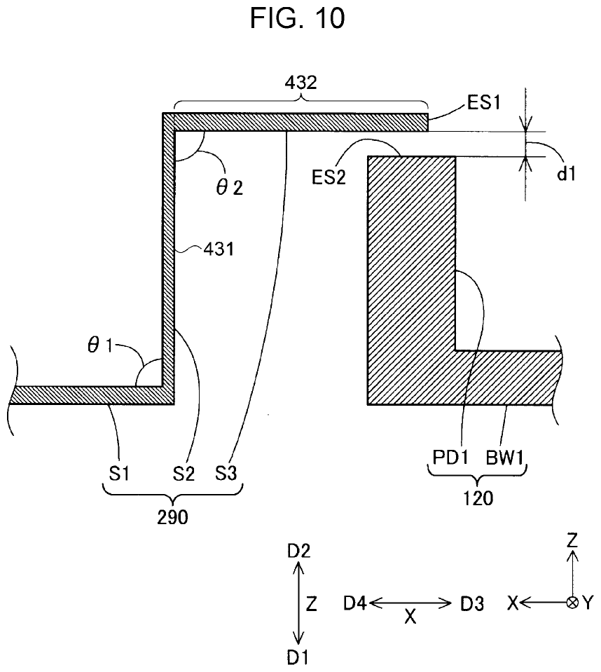

FIG. 7 is a bottom view of the liquid ejecting head 200. In FIG. 7, the components of the liquid ejecting head 200 stacked and fastened together are mounted on the carriage 120, and the liquid ejecting head 200 is viewed in plan view in the second direction D2. FIG. 8 is a cross-sectional view of the liquid ejecting head 200 and the carriage 120 taken along line VIII-VIII in FIG. 7. FIG. 9 is a magnified view of an area IX in FIG. 8. FIG. 10 is a magnified view of the cover 290 and the carriage 120 in FIG. 9. In FIGS. 8 and 9, the screws 293 and 295 are not illustrated. In FIG. 9, the nozzle plate 280, the flow channel forming member 270, the vibration plate 260, and the case head 250 are illustrated as one component. The arrangement of the cover 290 and the carriage 120 is the same at the sides in the +X direction, −X direction, +Y direction, and the +Y axis direction. In FIGS. 9 and 10, the arrangement at the side in the −X direction is described as an example.

As illustrated in FIG. 7, the liquid ejecting head 200 is attached to the carriage 120 with the components of the liquid ejecting head 200 being fastened together such that the surface of the nozzle plate 280 facing in the first direction D1 is exposed to the opening 292 of the cover 290. In other words, the nozzles 282 are exposed in the opening 292 of the cover 290. The bottom portions of the carriage 120 surround the nozzle plate 280 when viewed in the second direction D2. Of the bottom portions of the carriage 120, the bottom portion BW1 is adjacent to the nozzle plate 280 in the −X direction and the bottom portion BW2 is adjacent to the nozzle plate 280 in the +X direction.

As illustrated in FIG. 8, at the −X direction side and the +X direction side of the cover 290, the first surface S1 of the cover 290 covers portions of the surface of the nozzle plate 280 facing in the first direction D1. At the −X direction side of the cover 290, the second surface S2 of the cover 290 covers a surface of the nozzle plate 280, a surface of the flow channel forming member 270, and a surface of the vibration plate 260, which face in the −X direction, and a portion of a surface of the case head 250 facing in the −X direction. At the −X direction side of the cover 290, the first eaves portion 432 of the cover 290 having the third surface S3 extends along the X axis in the −X direction and is located away in the first direction D1 from the connector Cn2, which is located on the surface of the circuit board 230 facing in the first direction D1. The third surface S3 overlaps, at the end in the −X direction, the connector Cn2 and the +X direction end of the carriage 120 when view in the second direction D2.

Furthermore, as illustrated in FIGS. 6 and 8, the connector Cn2 is away in the third direction D3 from a first side wall 250A of the case head 250, which is located at the end in the third direction D3. The connector Cn2 includes a first housing 491 having an opening that receives the flexible flat cable 113A and multiple first connection terminals 501 coupled to wiring lines on the supported surface 230A of the circuit board 230. The first housing 491 has a substantially rectangular cuboidal shape and the long sides thereof extend in the Y axis direction. The first connection terminals 501 are located on the surface of the first housing 491 facing in the fourth direction D4. The first connection terminals 501 are arranged in the fifth direction D5. In this embodiment, the number of first connection terminals 501 is 21. The first housing 491 has an opening for the flexible flat cable 113A in the side surface facing in the third direction D3.

The first eaves portion 432 protrudes in the third direction D3 relative to the first side wall 250A of the case head 250. Furthermore, the first eaves portion 432 extends in the fifth direction D5 and overlaps the first connection terminals 501. In this embodiment, the first eaves portion 432 overlaps all the first connection terminals 501 when viewed in the second direction D2. In this configuration, when viewed in the second direction D2, the first connection terminals 501 are covered by the first eaves portion 432 and not exposed to the outside. This reduces the risk of adhesion of ink to the first connection terminals 501.

Furthermore, the protruding edge of the first eaves portion 432 located at the end in the third direction D3 overlaps the first housing 491 when viewed in the second direction D2. In other words, the first eaves portion 432 does not cover a portion of the first housing 491 when viewed in the second direction D2. In this configuration, ink is less likely to adhere to the first connection terminals 501 than in a configuration in which the edge of the first housing 491 located at the end in the fourth direction D4 and the protruding edge of the first eaves portion 432 are aligned, which is an example of configurations in which the protruding edge of the first eaves portion 432 located at the end in the third direction D3 does not overlap the first housing 491. Furthermore, the configuration in the embodiment contributes to a reduction in size of the liquid ejecting head 200 unlike a configuration in which the first eaves portion 432 protrudes from the first housing 491 in the third direction D3.

Furthermore, the first eaves portion 432 is not in contact with the components of the liquid ejecting head 200 other than the first eaves portion 432. Specifically described, as illustrated in FIG. 10, of the first side plate 431 having the second surface S2 and the first eaves portion 432 having the third surface S3, the first eaves portion 432 is a portion other than the portion of the first side plate 431 in contact with the first side wall 250A. In other words, the first eaves portion 432 is a portion of the cover 290 corresponding to the third surface S3 when view in the second direction D2. The first eaves portion 432 is not in contact with the components of the liquid ejecting head 200 at the surfaces facing in the second direction D2, the first direction D1, the third direction D3, the fifth direction D5, and the sixth direction D6. In other words, the first eaves portion 432 is a cantilevered portion fixed to the first side plate 431 at one end. In this configuration, stress applied to the cover 290 is reduced and the cover 290 is less likely to detach from the case head 250. The first eaves portion 432 may be in contact with a portion of the carriage 120. However, in view of stress, the first eaves portion 432 may be away from the carriage 120.

At the +X direction side of the cover 290, the fourth surface S4 of the cover 290 covers a surface of the nozzle plate 280, a surface of the channel forming member 270, and a surface of the vibration plate 260, which face in the +X direction, and a portion of a surface of the case head 250 facing in the +X direction. At the +X direction side of the cover 290, the second eaves portion 442 of the cover 290 having the fifth surface S5 extends along the X axis in the +X direction and is located away in the first direction D1 from the connector Cn4, which is located on the surface of the circuit board 230 facing in the first direction D1. The fifth surface S5 overlaps, at the end in the +X direction, the connector Cn4 and the −X direction end of the carriage 120 when view in the second direction D2.

Furthermore, as illustrated in FIGS. 6 and 8, the connector Cn4 is away in the fourth direction D4 from a second side wall 250B of the case head 250, which is located at the end in the fourth direction D4. The connector Cn4 includes a second housing 492 having an opening that receives the flexible flat cable 113B and multiple second connection terminals 502 coupled to wiring lines on the supported surface 230A of the circuit board 230. The second housing 492 has a substantially rectangular cuboidal shape and the long sides thereof extend in the Y axis direction. The second connection terminals 502 are located on the surface of the second housing 492 facing in the third direction D3. The second connection terminals 502 are arranged in the fifth direction D5. In this embodiment, the number of second connection terminals 502 is 21. The second housing 492 has an opening for the flexible flat cable 113B in the side surface facing in the fourth direction D4.

The second eaves portion 442 protrudes in the fourth direction D4 relative to the second side wall 250B of the case head 250. Furthermore, the second eaves portion 442 extends in the fifth direction D5 and overlaps the second connection terminals 502. In this embodiment, the second eaves portion 442 overlaps all the second connection terminals 502 when viewed in the second direction D2. In this configuration, when viewed in the second direction D2, the second connection terminals 502 are covered by the second eaves portion 442 and not exposed to the outside.

The following describes how the size of the circuit board 230 of the liquid ejecting head 200 is reduced in this embodiment. In the liquid ejecting head 200 according to this embodiment, ten nozzle arrays 281 are arranged along the X axis. This may increase the size of the liquid ejecting head 200 in the direction along the X axis. Furthermore, the circuit board 230 tends to be large, because wiring lines routed on the circuit board 230 become longer as the number of nozzle arrays increases 281. The wiring lines need to be arranged close to each other on the circuit board 230 to prevent the circuit board 230 from increasing in size. The wiring lines are efficiently and densely routed when the connectors Cn1, Cn2, Cn3, and Cn4 are disposed on the ends of the circuit board 230 in the long-side direction (X axis), not on the ends in the short-side direction (Y axis). Since the dimension of the circuit board 230 in the fifth direction D5 is larger than the dimension of the connectors Cn1, Cn2, Cn3, and Cn4 in the fifth direction D5, the connectors Cn1, Cn2, Cn3, and Cn4 are able to be disposed at the ends in the long-side direction (X axis) of the circuit board 230.

The long sides of the connectors Cn1, Cn2, Cn3, and Cn4 are shorter than the long sides of the circuit board 230. Thus, if the connectors Cn1, Cn2, Cn3, and Cn4 are disposed along the long-side ends of the circuit board 230, the circuit board 230 would have wasted space without the wiring lines, increasing the size of the circuit board 230. Furthermore, the connectors Cn1, Cn2, Cn3, and Cn4 and wiring lines may be disposed on both surfaces of the circuit board 230 to prevent the circuit board 230 from increasing in size and to allow the circuit board 230 to have sufficient space for the wiring lines. In such a case, the first and second connection terminals 501 and 502 of the connectors Cn2 and Cn4 on the supported surface 230A, which is a lower surface of the circuit board 230, are exposed to the lower side (adjacent to the print area). This may allow ink to adhere to the first and second connection terminals 501 and 502 due to ink splatter or ink mist caused during wiping or due to ink moved up along a side surface of the liquid ejecting head 200, leading to an electrical defect.

The present embodiment achieves the dense wiring layout and prevents the circuit board 230 from increasing in size as described above, although ten nozzle arrays 281 arranged in the third direction D3 increase the length of the liquid ejecting head 200 in the third direction D3. Furthermore, the first and second eaves portions 432 and 442 reduce ink adhesion to the first and second connection terminals 501 and 502 of the connectors Cn2 and Cn4.

The circuit board 230 of this embodiment does not have through holes for the screws 293, 294, 295, and 296, which fasten the components of the liquid ejecting head 200 together, to increase the arrangement density of the wiring lines on the circuit board 230. As described above, when the number of nozzle arrays 28 is relatively large, the wiring lines need to be densely arranged on the circuit board 230. Thus, it may be impossible for the circuit board 230 to have through holes for the screws 293, 294, 295, and 296, which fix the circuit board 230 to the case head 250. Furthermore, since the liquid ejecting head 200 having the nozzle arrays 28 arranged along the X axis is required to have a smaller width, it may be impossible to have the screws 293, 294, 295, and 296 on an outer side of the circuit board 230 in the X axis.

In this embodiment, the circuit board 230 is supported by a support surface 254 (FIG. 3) while being sandwiched between inner wall surfaces 251 and 252 of the case head 250. The inner wall surface 251 is located on the +Y direction side of the screws 294 and 296. The inner wall surface 252 is located on the −Y direction side of the screws 293 and 295. This allows the circuit board 230 to be positionally fixed without having through holes for the screws 293, 294, 295, and 296, enabling the circuit board 230 to have an enough wiring line formation area.

Furthermore, a fastening screw may be disposed between the nozzle plate 280 and the connector Cn2 (or Cn4) in the long-side direction (X axis) of the liquid ejecting head 200 when the liquid ejecting head 200 is viewed in the second direction D2. However, in such a case, the connector Cn2 (or Cn4) needs to be away from the nozzle plate 280 to have a space for the screw. This increases the size of the circuit board 230. In this embodiment, the fastening screws 293, 294, 295, and 296 are located away from the circuit board 230 in the short-side direction (Y axis) to downsize the circuit board 230. However, when the circuit board 230 is downsized, the connector Cn2 (or Cn4) is positioned near the nozzle plate 280, increasing the risk of ink adhesion problem. In this embodiment, the first eaves portion 432 (and the second eaves portion 442) solves the ink adhesion problem.

As illustrated in FIGS. 6 and 8, the protruding edge of the second eaves portion 442 located at the end in the fourth direction D4 overlaps the second housing 492 when viewed in the second direction D2. In other words, the second eaves portion 442 does not cover a portion of the second housing 492 when viewed in the second direction D2. In this configuration, ink is less likely to adhere to the second connection terminals 502 than in a configuration in which the edge of the second housing 492 located at the end in the third direction D3 and the protruding edge of the second eaves portion 442 are aligned, which is an example of configurations in which the edge of the second eaves portion 442 located at the end in the fourth direction D4 does not overlap the second housing 492. Furthermore, the configuration in the embodiment contributes to a reduction in size of the liquid ejecting head 200 unlike a configuration in which the second eaves portion 442 protrudes from the second housing 492 in the fourth direction D4.

Furthermore, the second eaves portion 442 is not in contact with the components of the liquid ejecting head 200 other than the second eaves portion 442. Specifically described, as the first eaves portion 432, of the second side plate 441 having the fourth surface S4 and the second eaves portion 442, the second eaves portion 442 is a portion other than the portion of the second side plate 441 in contact with the second side wall 250B of the case head 250. The second eaves portion 442 is not in contact with the components of the liquid ejecting head 200 at the surfaces facing in the second direction D2, the first direction D1, the fourth direction D4, the fifth direction D5, and the sixth direction D6. In other words, the second eaves portion 442 is a cantilevered portion fixed to the second side plate 441 at one end. In this configuration, stress applied to the cover 290 is reduced and the cover 290 is less likely to detach from the case head 250. The second eaves portion 442 may be in contact with a portion of the carriage 120. However, in view of stress, the second eaves portion 442 may be away from the carriage 120.

As illustrated in FIG. 9, the cover 290 has two bent portions TP1 and TP2 and is a single member bent in predetermined directions at the bent portions TP1 and TP2. Specifically described, the first bent portion TP1 is where the first surface S1 is bent in the second direction D2 at the end in the third direction D3, and the first surface S1 and the second surface S2 are continuous through the first bent portion TP1. The second bent portion TP2 is where the second surface S2 is bent in the third direction D3 at the end in the second direction D2, and the second surface S2 and the third surface S3 are continuous through the second bent portion TP2.

As illustrated in FIG. 10, the first surface S1 and the second surface S2 form an angle θ1 of 90°. The “angle between the first surface S1 and the second surface S2” is a connection angle between the first surface S1 and the second surface S2 and is an interior angle of the first bent portion TP1, which is a bent portion of the cover 290. The second surface S2 and the third surface S3 form an angle θ2 of 90°. The “angle between the second surface S2 and the third angle S3” is a connection angle between the second surface S2 and the third surface S3 and is an interior angle of the second bent portion TP2, which is a bent portion of the cover 290.

Although not illustrated in FIGS. 9 and 10, the cover 290 has two bent portions at the +X direction side of the cover 290 as at the −X direction side of the cover 290. As illustrated in FIGS. 4 and 8, the first surface S1 is bent in the second direction D2 at the end in the +X direction to form the bent portion. The first surface S1 and the fourth surface S4 are continuous through the bent portion. The first surface S1 and the fourth surface S4 form an angle of 90°. Furthermore, the fourth surface S4 is bent in the +X direction at the end in the second direction D2 to form a bent portion. The fourth surface S4 and the fifth surface S5 are continuous through the bent portion. The fourth surface S4 and the fifth surface S5 form an angle of 90°.

As illustrated in FIGS. 8 and 9, the carriage 120 includes protruded portions PD1 and PD2 and side walls SW1 and SW2 in addition to the above-described bottom walls BW1 and BW2. The bottom walls BW1 and BW2, the protruded portions PD1 and PD2, and the side walls SW1 and SW2 function as outer walls of the carriage 120. The bottom walls BW1 and BW2 extend in the direction along the X axis and function as the bottom surfaces of the carriage 120. The bottom walls BW1 and BW2 may extend substantially in the direction along the X axis. The protruded portion PD1 protrudes in the second direction D2 from the end in the fourth direction D4 of the bottom wall BW1. The protruded portion PD2 protrudes in the second direction D2 from the end in the third direction D3 of the bottom wall BW2. The side wall SW1 protrudes in the second direction D2 from the end in the third direction D3 of the bottom wall BW1. The side wall SW2 protrudes in the second direction D2 from the end in the fourth direction D4 of the bottom wall BW2. The protruded portions PD1 and PD2 and the side walls SW1 and SW2 function as side surfaces of the carriage 120. Although not illustrated, the bottom walls, the protruded portions, and the side walls of the carriage 120 are disposed not only at the +X direction side and the −X direction side of the liquid ejecting head 200 and also disposed at the +Y direction side, the −Y direction side, and the sides intersecting the X direction and the Y direction. The bottom walls, the protruded portions, and the side walls surround the nozzle plate 280 when viewed in the second direction D2.

As illustrated in FIG. 10, the protruded portion PD1 of the carriage 120 is away from the third surface S3 of the cover 290 in the first direction D1 and the protruded portion PD1 has an end ES2 facing in the second direction D2 with a distance from the third surface S3. The minimum distance dl between the end ES2 of the protruded portion PD1 and the third surface S3 is, for example, 0.6 mm. The cover 290 has an end ES1 at the end in the third direction D3 of the third surface S3, and the end ES1 overlaps the protruded portion PD1 of the carriage 120 when viewed in the second direction D2.

As illustrated in FIG. 8, a portion of the flexible flat cable 113 is housed in the carriage 120. Specifically described, at the −X direction side of the liquid ejecting head 200, a portion of the flexible flat cable 113 is surrounded by the side wall SW1 of the carriage 120, the liquid ejecting head 200, and the bottom wall BW1 of the carriage 120. At the +X direction side of the liquid ejecting head 200, a portion of the flexible flat cable 113 is also surrounded by the side wall SW2 of the carriage 120, the liquid ejecting head 200, and the bottom wall BW2 of the carriage 120. The connector Cn2 has an insertion slot CP2 positioned away in the third direction D3 from the position where the outer wall of the carriage 120 overlaps the third surface S3 when viewed in the second direction D2. The connector Cn4 has an insertion slot CP4 positioned away in the fourth direction D4 from a position where the outer wall of the carriage 120 overlaps the fifth surface S5 when viewed in the second direction D2.

### A4. Wiping Process

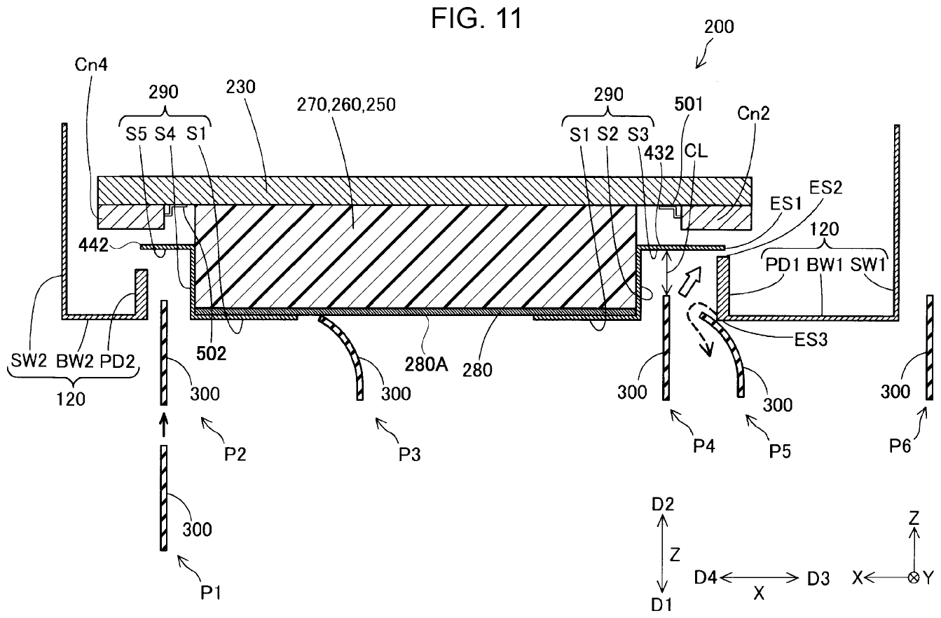

FIG. 11 is an explanatory view schematically illustrating how a wiping process is performed. The wiping process removes ink on the surface of the nozzle plate 280 facing in the first direction D1 with a wiping member 300 included in the liquid ejecting apparatus 100. Ink may adhere to the nozzle plate 280, for example, when ink droplets ejected through the nozzles 282 are partly turned into a form of mist or when ink droplets ejected through the nozzles 282 are partly bounced back from the print medium P. As the amount of ink on the nozzle plate 280 increases, meniscus in the nozzles 282 is more likely to be damaged. This may result in defective ejection of ink droplets from the liquid ejecting head 200, leading to problems, such as missing dots on the print medium P. To avoid the problems, in the liquid ejecting apparatus 100, cleaning such as a wiping process is performed in accordance with instructions from the user or the controller 110.

In this embodiment, the wiping member 300 includes a wiper blade formed of a soft resin, such as rubber and an elastomer. The wiping member 300 moves in the third direction D3 or the fourth direction D4 relative to a nozzle surface 280A having the nozzles 282 while in contact with the surface of the nozzle plate 280 facing in the first direction D1 at an end portion. This removes the ink on the nozzle surface 280A of the nozzle plate 280. Furthermore, although the nozzle surface 280A is wiped with the wiping member 300 moving in the third direction D3 or the fourth direction D4, ink does not adhere to the first and second connection terminals 501 and 502 because the first and second eaves portions 432 and 442 block the ink splashed by the wiping. The wiping member 300 may be an absorber, such as a fabric roller that absorbs and holds ink droplets.

As illustrated in FIG. 11, in this embodiment, when the wiping process starts, the wiping member 300 at the position P1 is moved by a driving mechanism (not illustrated) in the second direction D2 to the position P2. When the wiping member 200 is at the position P2, a portion of the wiping member 200 at the end in second direction D2 is in a gap between the carriage 120 and the cover 290, specifically, in a space defined by the protruded portion PD2 of the carriage 120, the fifth surface S5 of the cover 290, and the fourth surface S4 of the cover 290. At this time, the +Z direction end of the wiping member 300 is not in contact with the fifth surface S5 of the cover 290. Then, as indicated by the position P3, the wiping member 300 moves in the third direction D3 relative to the liquid ejecting head 200. At this time, the wiping member 300 is moved in the third direction D3 by the driving mechanism while in contact with the surface of the nozzle plate 280 facing in the first direction D1 and being slightly deformed. This removes ink on the nozzle plate 280. The relative movement between the wiping member 300 and the liquid ejecting head 200 in the direction along the X axis may be achieved by moving the wiping member 300 in the −X direction relative to the liquid ejecting head 200 or moving the liquid ejecting head 200 in the +X direction relative to the wiping member 300.

When the wiping of the nozzle plate 280 is finished, the wiping member 300 moves to the position P4. The deformed portion of the wiping member 300 at the end in the second direction D2 returns to the original shape, and the portion of the wiping member 300 at the end in the second direction D2 is in a gap between the carriage 120 and the cover 290, specifically, in a space defined by the second surface S2 of the cover 290, the third surface S3 of the cover 290, and the protruded portion PD1 of the carriage 120. In this embodiment, there is a clearance CL between the end of the wiping member 300 facing in the second direction D2 and the third surface S3 of the cover 290. The wiping member 300 is not in contact with the third surface S3 of the cover 290. The size of the clearance CL is, for example, 1 mm or more. The size of the clearance CL is not limited to 1 mm or more and may be any size. Alternatively, the wiping member 300 may be in contact with the third surface S3 of the cover 290 without the clearance CL.

Here, in the configuration in which the wiping member 300 is moved in the third direction D3 relative to the nozzle surface 280A while in contact with the nozzle plate 280, as illustrated in FIG. 6, a dimension L2 of the first eaves portion 432 in the third direction D3 is larger than a dimension L4 of the second eaves portion 442 in the third direction D3. When the wiping member 300 moves in the third direction D3 to wipe the nozzle plate 280, ink splatters more at the downstream end in the third direction D3 of the nozzle surface 280A than at the upstream end of the nozzle surface 280A, because the amount of wiped ink increases. Furthermore, the ink dragged by the wiping member 300 is likely to move onto the cover 290. Since the wiping member 300 is moved from the smaller second eaves portion 442 toward the larger first eaves portion 432 to wipe the nozzle surface 280A, the influence of the ink splattered during the wiping is limited. Furthermore, the ink moved up along the side surface of the cover 290 is unlikely to reach the protruding edge of the first eaves portion 432. Furthermore, the cover 290 in this configuration is smaller than that having large first and second eaves portion 432 and 442, leading to a reduction in cost.

Furthermore, in this configuration in which the wiping member 300 is moved in the third direction D3 relative to the nozzle surface 280A while in contact with the nozzle plate 280, as illustrated in FIG. 6, the dimension L1 of the first eaves portion 432 in the fifth direction D5 is larger than the dimension L3 of the second eaves portion 442 in the fifth direction D5. As described above, since the ink splatters more at the downstream end in the third direction D3 of the nozzle surface 280A than at the upstream end of the nozzle surface 280A, the larger first eaves portion 432 reduces the influence of the splattered ink.

In the configuration in which the wiping member 300 is moved in the third direction D3 relative to the nozzle surface 280A while in contact with the nozzle plate 280, only the dimension L1 of the first eaves portion 432 and the dimension L3 of the second eaves portion 442 may be specified, and the dimension L2 of the first eaves portion 432 and the dimension L4 of the second eaves portion 442 may have any values. In other words, only the dimension L1 of the first eaves portion 432 in the fifth direction D5 needs to be larger than the dimension L3 of the second eaves portion 442 in the fifth direction D5. This also provides the above-described advantages.

When the wiping member 300 arrives at the position P4, the wiping member 300 returns to the original shape before the wiping, and the ink droplets on the wiping member 300 are splattered toward the third surface S3 of the cover 290 and the protruded portion PD1 of the carriage 120 as indicated by a hollow arrow. As described above, in this embodiment, the third surface S3 of the cover 290 overlaps the protruded portion PD1 of the carriage 120 when viewed in the second direction D2. Thus, when the ink droplets are splattered toward the third surface S3 and the protruded portion PD1, the ink droplets are unlikely to enter the carriage 120 through the gap between the third surface S3 and the protruded portion PD1.

When the wiping member 300 arrives at the position P5, the wiping member 300 is in contact with an end ES3 of the protruded portion PD1 of the carriage 120, which is located at an end in the first direction D1, and the ink droplets on the wiping member 300 flow in the first direction D1 as indicated by a broken arrow. Then, the wiping member 300 is moved in the third direction D3 while in contact with the bottom wall BW1 of the carriage 120. Then, when the wiping member 300 arrives at the position P6 away from the side wall SW1 of the carriage 120 in the third direction D3, the wiping member 300 is out of contact with the bottom wall BW1 of the carriage 120. This is the end of the wiping process.

In the liquid ejecting apparatus 100 of the above-described embodiment, the third surface S3 of the cover 290 extends in the third direction D3 from the second surface S2 of the cover 290 and is not in contact with the protruded portion PD1 of the carriage 120, and the end ES1 of the third surface S3 at the end in third direction D3 overlaps the protruded portion PD1 of the carriage 120 when viewed in the second direction D2. In this configuration, ink is unlikely to enter the carriage 120 through the gap between the cover 290 and the carriage 120. In addition, since the third surface S3 of the cover 290 is not in contact with the protruded portion PD1 of the carriage 120, the third surface S3 is unlikely to receive the stress generated when the cover 290 is detached from the liquid ejecting head 200.

The third surface S3 is located away from the connector Cn2 in the first direction D1. In this configuration, ink is unlikely to adhere to the connector Cn2.

The outer wall of the carriage 120 is located away from the third surface S3 in the first direction D1. The outer wall includes the bottom wall BW1 and the protruded portion PD1 extending from the bottom wall BW1 toward the third surface S3. In this configuration, when ink droplets are splattered toward the carriage 120, the ink droplets are unlikely to enter the carriage 120.

The first surface S1 and the second surface S2 form the angle θ1 of 90°. In this configuration, positioning of the cover 290 and the case head 250 is easy. In addition, the second surface S2 and the third surface S3 form the angle θ2 of 90°. This makes production of the cover 290 easy.

The minimum distance dl between the protruded portion PD1 and the third surface S3 in the first direction D1 is 1 mm or smaller at a position where the protruded portion PD1 overlaps the third surface S3 when viewed in the second direction D2. The gap between the protruded portion PD1 and the third surface S3 is small. In this configuration, ink is unlikely to enter the carriage 120 through the gap between the third surface S3 and the carriage 120. The minimum distance dl is not limited to 0.6 mm and may be any value in a range of not less than 0.2 mm and not more than 1 mm. The smaller minimum distance dl the better. The ink is less likely to enter the carriage 120 through the gap between the third surface S3 and the carriage 120 as the minimum distance dl decreases.

This configuration includes the wiping member 300 that wipes the surface of the nozzle plate 280 facing in the first direction D1. Unlike a configuration not having the wiping member 300, this configuration readily removes the ink droplets on the nozzle plate 280. Thus, in the liquid ejecting apparatus 100, a defect caused by the ink on the nozzle plate 280 is reduced.

The wiping member 300 is moved in the third direction D3 relative to the liquid ejecting head 200 while in contact with the surface of the nozzle plate 280 facing in the first direction D1. In this configuration, the third surface S3 of the cover 290 extends in the movement direction of the wiping member 300. When ink droplets are splattered during wiping of the nozzle plate 280, the third surface S3 blocks ink droplets from entering the carriage 120.

The nozzle arrays 281 are arranged in the third direction D3. This configuration enables the movement direction of the wiping member 300 and the arrangement direction of the nozzle arrays 281 to be the same, leading to downsizing of the wiping member 300. Furthermore, this configuration enables the movement direction of the wiping member 300 and the scanning direction of the carriage 120 to be the same, allowing the wiping member 300 to wipe the nozzle plate 280 when the carriage 120 scans.

The wiping member 300, which is not in contact with the third surface S3, is housed in the space between the cover 290 and the carriage 120, leading to downsizing of the liquid ejecting apparatus 100.

The clearance CL of 1 mm or more is provided between the end of the wiping member 300 facing in the second direction D2 and the third surface S3. This reduces the possibility that the ink on the front end of the wiping member 300 will adhere to the third surface S3.

The insertion slot CP2 of the connector Cn2 is located away in the third direction D3 from the position where the outer wall of the carriage 120 overlaps the third surface S3 when viewed in the second direction D2. In this configuration, the insertion slot CP2 is away from the gap between the outer wall of the carriage 120 and the third surface S3, reducing the risk of adhesion of ink to the insertion slot CP2 of the connector Cn2.

What is claimed is:

1. A liquid ejecting head comprising:
a nozzle plate including nozzle arrays having nozzles configured to eject a liquid in a first direction;
a case head that is disposed in a second direction opposite to the first direction with respect to the nozzle plate and that has flow channels in communication with the nozzles;
a circuit board that is disposed in the second direction with respect to the case head and that has a supported surface supported by the case head;
a first connector disposed on the supported surface of the circuit board; and
a cover that has an opening in which the nozzles are exposed and that covers a portion of the nozzle plate, wherein
the nozzle arrays are arranged in a third direction perpendicular to the first direction,
the case head includes a first side wall located at an end in the third direction thereof,
the first connector that is away in the third direction from the first side wall of the case head and that includes first connection terminals arranged in a fifth direction perpendicular to the first direction and the third direction on the supported surface, and
the cover includes a first eaves portion protruding in the third direction with respect to the first side wall and extending in the fifth direction to overlap the first connection terminals.

2. The liquid ejecting head according to claim 1, further comprising a screw fixing the cover and the case head, wherein
the first eaves portion is not in contact with the components of the liquid ejecting head other than the first eaves portion.

3. The liquid ejecting head according to claim 1, further comprising a second connector disposed on the supported surface of the circuit board, wherein
the nozzle arrays include ten nozzle arrays,
the case head includes a second side wall located at an end in a fourth direction opposite to the third direction thereof,
the second connector that is away in the fourth direction from the second side wall of the case head and that includes second connection terminals arranged in the fifth direction on the supported surface, and
the cover includes a second eaves portion protruding in the fourth direction with respect to the second side wall and extending in the fifth direction to overlap the second connection terminals.

4. The liquid ejecting head according to claim 3, further comprising a screw fixing the cover and the case head, wherein
the first eaves portion is not in contact with the components of the liquid ejecting head other than the first eaves portion, and
the second eaves portion is not in contact with the components of the liquid ejecting head other than the second eaves portion.

5. A liquid ejecting apparatus comprising:
the liquid ejecting head according to claim 1; and
a first signal cable inserted into the first connector.

6. A liquid ejecting apparatus comprising:
the liquid ejecting head according to claim 2; and
a first signal cable inserted into the first connector.

7. The liquid ejecting apparatus according to claim 5, wherein
the first connector includes a first housing receiving the first signal cable, and
a protruding edge of the first eaves portion overlaps the first housing when viewed in the second direction.

8. The liquid ejecting apparatus according to claim 6, wherein
the first connector includes a first housing receiving the first signal cable, and
a protruding edge of the first eaves portion overlaps the first housing when viewed in the second direction.

9. A liquid ejecting apparatus comprising:
the liquid ejecting head according to claim 3;
a first signal cable inserted into the first connector; and
a second signal cable inserted into the second connector.

10. A liquid ejecting apparatus comprising:
the liquid ejecting head according to claim 4;
a first signal cable inserted into the first connector; and
a second signal cable inserted into the second connector.

11. The liquid ejecting apparatus according to claim 9, wherein
the first connector includes a first housing receiving the first signal cable,
the second connector includes a second housing receiving the second signal cable,
a protruding edge of the first eaves portion overlaps the first housing when viewed in the second direction, and
a protruding edge of the second eaves portion overlaps the second housing when viewed in the second direction.

12. The liquid ejecting apparatus according to claim 10, wherein
the first connector includes a first housing receiving the first signal cable,
the second connector includes a second housing receiving the second signal cable,
a protruding edge of the first eaves portion overlaps the first housing when viewed in the second direction, and
a protruding edge of the second eaves portion overlaps the second housing when viewed in the second direction.

13. A liquid ejecting apparatus comprising:
the liquid ejecting head according to claim 3; and
a wiping member configured to wipe the nozzle plate, wherein
the wiping member is moved in the third direction or the fourth direction relative to the nozzle plate while in contact with the nozzle plate.

14. A liquid ejecting apparatus comprising:
the liquid ejecting head according to claim 3; and
a wiping member configured to wipe the nozzle plate, wherein
the wiping member is moved in the third direction relative to the nozzle plate while in contact with the nozzle plate, and
the size of the first eaves portion in the third direction is longer than that of the second eaves portion in the third direction.

15. The liquid ejecting apparatus according to claim 14, wherein the size of the first eaves portion in the fifth direction is longer than that of the second eaves portion in the fifth direction.

16. A liquid ejecting apparatus comprising:
the liquid ejecting head according to claim 3; and
a wiping member configured to wipe the nozzle plate, wherein
the wiping member is moved in the third direction relative to the nozzle plate while in contact with the nozzle plate, and
the size of the first eaves portion in the fifth direction is longer than that of the second eaves portion in the fifth direction.

17. A method of wiping a liquid ejecting apparatus, the method comprising moving a wiping member in contact with a nozzle plate in a third direction relative to the nozzle plate, wherein
the liquid ejecting apparatus includes a liquid ejecting head and the wiping member configured to wipe the nozzle plate, and the liquid ejecting head includes
a nozzle plate including nozzle arrays having nozzles configured to eject a liquid in a first direction,
a case head that is disposed in a second direction opposite to the first direction with respect to the nozzle plate and that has flow channels in communication with the nozzles,
a circuit board that is disposed in the second direction with respect to the case head and that has a supported surface supported by the case head,
a first connector disposed on the supported surface of the circuit board,
a second connector disposed on the supported surface of the circuit board,
a cover that has an opening in which the nozzles are exposed and that covers a portion of the nozzle plate, and
a screw fixing the cover and the case head, wherein
the nozzle arrays are arranged in the third direction perpendicular to the first direction,
the case head includes a first side wall located at an end in the third direction thereof and a second side wall located at an end in a fourth direction opposite to the third direction thereof,
the first connector that is away in the third direction from the first side wall of the case head and that includes first connection terminals arranged in a fifth direction perpendicular to the first direction and the third direction on the supported surface,
the nozzle arrays include ten nozzle arrays,
the second connector that is away in the fourth direction from the second side wall of the case head and that includes second connection terminals arranged in the fifth direction on the supported surface,
the cover includes a first eaves portion protruding in the third direction with respect to the first side wall and extending in the fifth direction to overlap the first connection terminals and a second eaves portion protruding in the fourth direction with respect to the second side wall and extending in the fifth direction to overlap the second connection terminals,
the first eaves portion is not in contact with the components of the liquid ejecting head other than the first eaves portion,
the second eaves portion is not in contact with the components of the liquid ejecting head other than the second eaves portion, and
the size of the first eaves portion in the third direction is longer than that of the second eaves portion in the third direction.

18. A method of wiping a liquid ejecting apparatus, the method comprising moving a wiping member in contact with a nozzle plate in a third direction relative to the nozzle plate, wherein
the liquid ejecting apparatus includes a liquid ejecting head and the wiping member configured to wipe the nozzle plate, and the liquid ejecting head includes
a nozzle plate including nozzle arrays having nozzles configured to eject a liquid in a first direction,
a case head that is disposed in a second direction opposite to the first direction with respect to the nozzle plate and that has flow channels in communication with the nozzles,
a circuit board that is disposed in the second direction with respect to the case head and that has a supported surface supported by the case head,
a first connector disposed on the supported surface of the circuit board,
a second connector disposed on the supported surface of the circuit board,
a cover that has an opening in which the nozzles are exposed and that covers a portion of the nozzle plate, and
a screw fixing the cover and the case head, wherein
the nozzle arrays are arranged in the third direction perpendicular to the first direction,
the case head includes a first side wall located at an end in the third direction thereof and a second side wall located at an end in a fourth direction opposite to the third direction thereof,
the first connector that is away in the third direction from the first side wall of the case head and that includes first connection terminals arranged in a fifth direction perpendicular to the first direction and the third direction on the supported surface,
the nozzle arrays include ten nozzle arrays,
the second connector that is away in the fourth direction from the second side wall of the case head and that includes second connection terminals arranged in the fifth direction on the supported surface,
the cover includes a first eaves portion protruding in the third direction with respect to the first side wall and extending in the fifth direction to overlap the first connection terminals and a second eaves portion protruding in the fourth direction with respect to the second side wall and extending in the fifth direction to overlap the second connection terminals,
the first eaves portion is not in contact with the components of the liquid ejecting head other than the first eaves portion,
the second eaves portion is not in contact with the components of the liquid ejecting head other than the second eaves portion, and
the size of the first eaves portion in the fifth direction is longer than that of the second eaves portion in the fifth direction.
